(19) United States
(12) Patent Application Publication
(10) Pub. No.: US 2016/0213994 A1
(43) Pub. Date: Jul. 28, 2016

(54) ATHLETE SCORING AND RANKING SYSTEMS

(71) Applicant: Sponsorhouse, Inc. DBA Hookit, Solana Beach, CA (US)

(72) Inventors: Scott Tilton, San Diego, CA (US); Robert J. Kraus, Cardiff, CA (US); Michael Robinson, Escondido, CA (US)

(21) Appl. No.: 14/702,839

(22) Filed: May 4, 2015

Related U.S. Application Data
(60) Provisional application No. 62/106,810, filed on Jan. 23, 2015.

(51) Int. Cl. A63B 71/00; G06Q 30/02

(52) U.S. Cl. CPC A63B 71/00; G06Q 30/0208; G06Q 30/0236; G06Q 30/0242

(57) ABSTRACT

An athlete score generating device and a method thereof may include a commitment score calculating unit, a performance score calculating unit, a reach score calculating unit, and a total score generating unit. An athlete report generating device and a method thereof includes an athlete monitoring unit, a sport monitoring unit, and a report generating unit. An athlete rank generating device and a method thereof may include a data receiving unit, an athlete ranking unit, and an athlete rank generating unit.

### CROSS-REFERENCE TO RELATED APPLICATION

This application claims the benefit of U.S. Provisional Application No. 62/106,810, filed on Jan. 23, 2015, which is herein incorporated by reference in its entirety.

### BACKGROUND

1. Field

The following description relates to systems for scoring and ranking athletes, and methods thereof. For example, systems for scoring and ranking athletes may provide one or more athlete scores or rankings such as a score or ranking for helping an athlete or a company measure an athlete's overall value and/or influence, helping a company or a sponsor measure the general marketability, value, or influence of an athlete, and/or helping a company or a sponsor measure the marketability or influence of an athlete with respect to a specific brand or product.

2. Description of Related Art

Brands or companies often provide discounted or free merchandise to athletes for promoting their brand or company. Many factors may determine which athlete or group of athletes a brand or company will choose for promoting their products. At least one aspect used to make this determination is the general value and marketability of an athlete. Additionally, athletes are competitive, not only with respect to their sports, but also with respect to popularity, fame, and value.

The value and marketability of an athlete is typically used by athletes, fans, critics, media, and companies to determine their impact within a sport. Typically, a measurement of the familiarity and appeal of an athlete, brand, company, celebrity, or television show that is used is a Q Score. The higher the Q Score, the more highly regarded the person is among the group that is familiar with them. Q Scores and other variants are primarily used by the media, marketing, advertising, and public relations industries.

Q Score respondents are typically given the following choices for each person or item being surveyed: one of my favorites; very good; good; fair; poor; and never heard of. The score is calculated by dividing the percentage of respondents who answer “one of my favorites” by the total percentage of respondents who are familiar with the subject matter multiplied by 100. Accordingly, a level of the marketability of an athlete is typically determined by surveying a number of individuals within a group.

### SUMMARY

This Summary is provided to introduce a selection of concepts in a simplified form that are further described below in the Detailed Description. This Summary is not intended to identify key features or essential features of the invention, nor is it intended to be used as an aid in determining the scope of the claims.

In an aspect, an athlete score generating device for generating an athlete score for an athlete includes a commitment score calculator configured to calculate a commitment score using one or more commitment factors, a performance score calculator configured to calculate a performance score using one or more performance factors, a reach score calculator configured to calculate a reach score using one or more reach factors, and a total score generator configured to generate the athlete score using at least one of the commitment score, the performance score, and the reach score, wherein the commitment score calculator, the performance score calculator, the reach score calculator, and the total score generator include at least one processor.

In another aspect, an athlete score generating device includes an athlete score generator configured to generate an athlete score using a ratio of at least one of a commitment score, a performance score, and a reach score, and a hierarchy calculator configured to calculate a hierarchy level of an athlete using the athlete score, wherein the athlete score generator is configured to adjust the generating of the athlete score using the hierarchy level calculated by the hierarchy calculator, and the athlete score generator and the hierarchy calculator include at least one processor.

In another aspect, an athlete rank generating device includes a data receiving unit configured to receive data on social media activities of athletes or calculated athlete scores, a ranking unit configured to calculate a ranking of the athletes using the received data, and a rank generator configured to generate a ranking of the athletes using the calculated ranking, wherein the data receiving unit, the ranking unit, and the rank generator include at least one processor.

In another aspect, a method for promoting a brand using an athlete score includes receiving an application from an athlete requesting to join a program, reviewing the application and accepting the athlete using the application, or automatically accepting the athlete using the athlete score without reviewing the application, providing the accepted athlete with offers for purchasing merchandise, monitoring activity of the athlete including social media interactions, brand promotions, and performance of the athlete.

Other features and aspects may be apparent from the following detailed description and the drawings.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the invention.

FIG. 1 is a diagram illustrating an example of an environment where users can interact with an athlete scoring and ranking system.

FIG. 2 is a diagram illustrating an example of athlete scoring and ranking system.

FIG. 3 is a diagram illustrating an example of a method for promoting a brand or company.

FIG. 4 is a diagram illustrating an example of an athlete score for an athlete who belongs to an H2 hierarchy and the athlete score is a weighted value of a commitment score, a performance score, and a reach score.

FIG. 5 is a diagram illustrating an example of an athlete score for an athlete who belongs to an H1 hierarchy and the athlete score is a weighted value of a commitment score, a performance score, and a reach score.

FIG. 6 is a diagram illustrating an example of an athlete score for an athlete who belongs to an H3 hierarchy and the athlete score is a weighted value of a performance score and a reach score.

FIG. 7 is a diagram illustrating an example of an athlete report that may be provided to a specific company such as GoPro® and monitors a general value or a brand-specific value of one or more athletes.

FIG. 8 is a diagram illustrating an example of an athlete monitoring system including an athlete score generating device and an athlete report generating device.

FIG. 9 is a diagram illustrating an example of a user interface display that includes a total athlete score and an indicator for each weighted score that forms the total athlete score, such as a commitment score, a performance score, and a reach score.

FIG. 10 is a diagram illustrating an example of a dashboard for monitoring and/or ranking athlete activity including key metrics, an athlete map, and a ranking of top athletes.

FIG. 11 is a diagram illustrating an example of a dashboard for monitoring and/or ranking athlete activity including top social media content, athlete metrics by level, and hashtag campaign metrics.

FIG. 12 is a diagram illustrating an example of a method for promoting a brand based on an athlete score or other athlete related metrics and/or rankings.

FIG. 13 is a diagram illustrating an example of a report including a summary that may be provided to a specific company such as Dunlop® and monitors and/or ranks the interactions of one or more athletes.

FIG. 14 is a diagram illustrating an example of a report including posts that may be provided to a specific company such as Dunlop® and monitors and/or ranks the interactions of or with one or more athletes.

FIG. 15 is a diagram illustrating an example of a report including sales information that may be provided to a specific company such as Dunlop® and monitors and/or ranks the interactions of or with one or more athletes.

FIG. 16 is a diagram illustrating an example of athlete ranking based on social interactions.

FIG. 17 is a diagram illustrating an example of an engagement or interaction ranking and live stream during an event.

FIG. 18 is a diagram illustrating an example of an engagement or interaction ranking based on the social activities of one or more persons grouped in a team.

FIG. 19 is a diagram illustrating an example of a chart monitoring and/or comparing the interactions of one or more athletes during an event.

FIG. 20 is a diagram illustrating an example of a chart monitoring and/or comparing the interactions of one or more athletes during an event.

FIG. 21 is a diagram illustrating an example of an athlete monitoring system including an athlete score generating device, an athlete report generating device, and an athlete rank generating device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

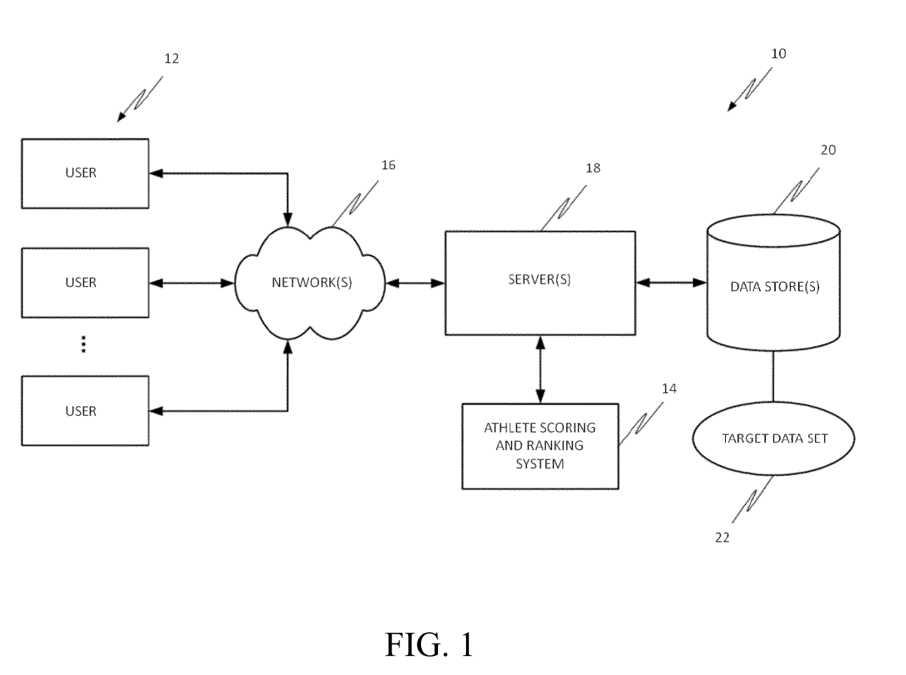

FIG. 1 depicts at 10 an environment wherein users 12 can interact with an athlete scoring and ranking system 14 to analyze one or more athlete scores and/or athlete rankings for evaluating a value or influence of the one or more athletes. The users 12, including the one or more athletes, fans, companies, among other users interested in analyzing the value or influence of the one or more athletes, can interact with the system 14 through a number of ways, such as over one or more networks 16. Server(s) 18 accessible through the network(s) 16 can host the system 14. One or more data stores 20 can store the data to be analyzed by the system 14 as well as any intermediate or final data generated by the system 14.

The system 14 can be an integrated web-based reporting and analysis tool that provides users flexibility and functionality for performing calculations of an athlete score using one or more inputs from the one or more athlete users and generating an athlete score and/or athlete ranking using the one or more inputs. It should be understood that the system 14 could also be provided on a stand-alone computer for access by a user.

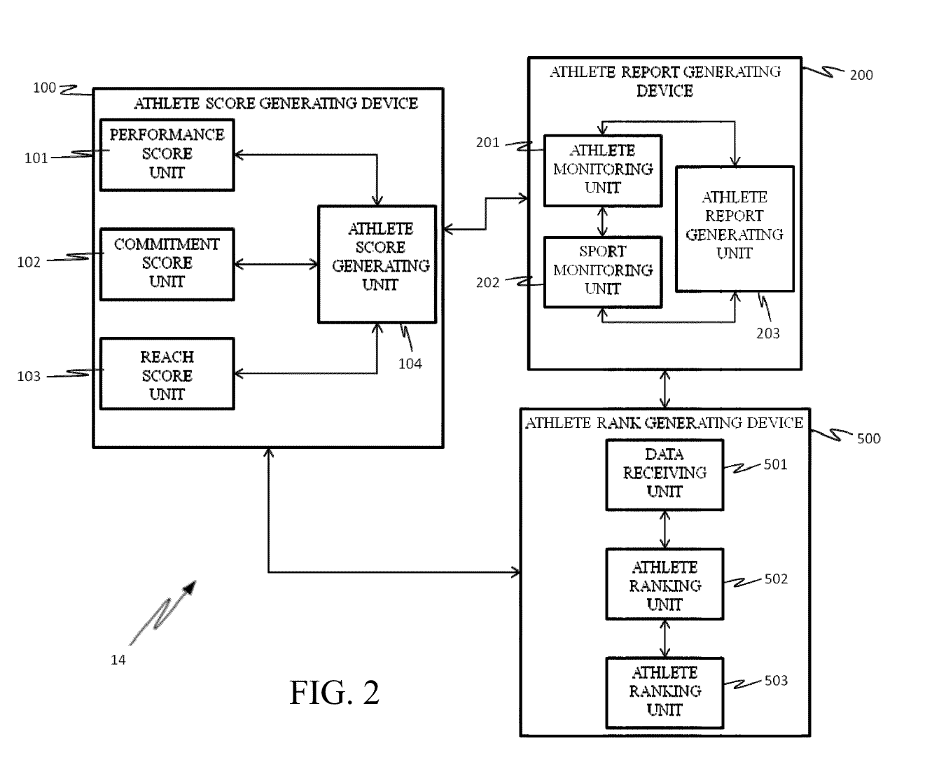

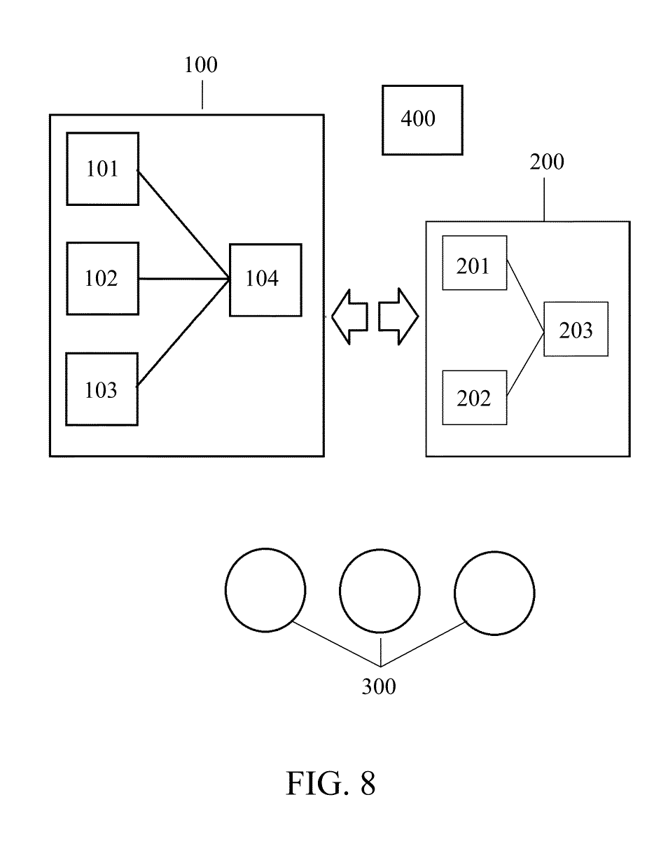

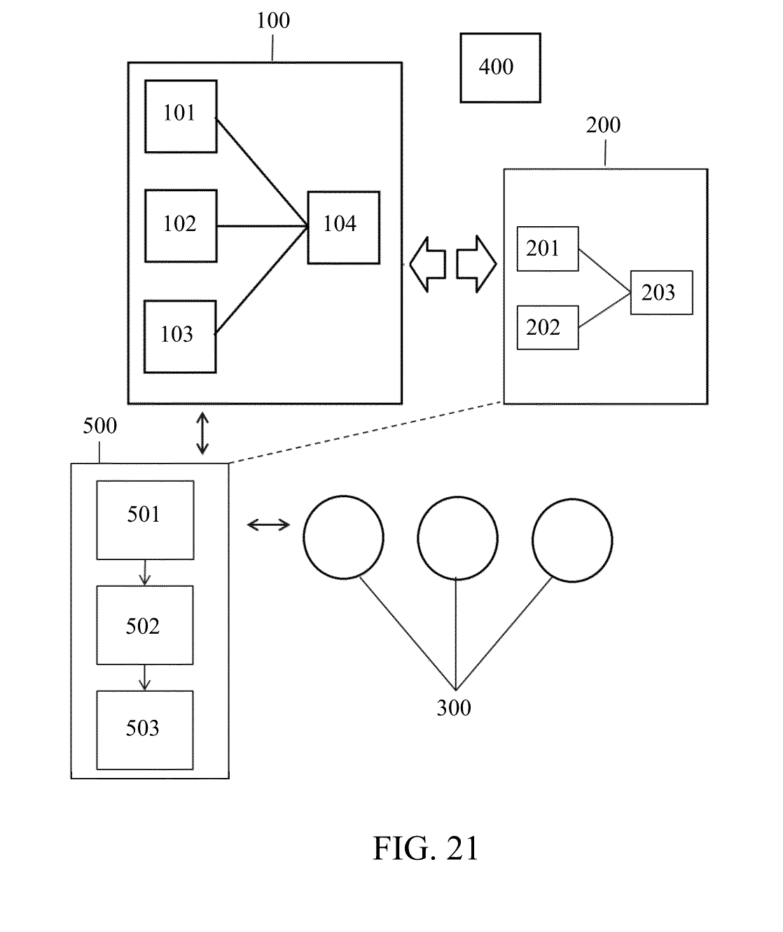

FIG. 2 is a diagram illustrating an example of an athlete scoring and ranking system 14. Referring to FIG. 2, an athlete scoring and ranking system 14 may include an athlete score generating device 100, an athlete report generating device 200, and an athlete rank generating device 500. An athlete score generating device 100 includes a performance score unit 101, a commitment score unit 102, a reach score unit 103, and an athlete score generating unit 104. An athlete report generating device 200 includes an athlete monitoring unit 201, a sport monitoring unit 202, and an athlete report generating unit 203. An athlete rank generating device 500 may include a data receiving unit 501, an athlete ranking unit 502, and an athlete rank generating unit 503. The athlete score generating device 500, the athlete report generating device 200, and the athlete rank generating device 500 are also described further below in reference with FIGS. 8 and 21.

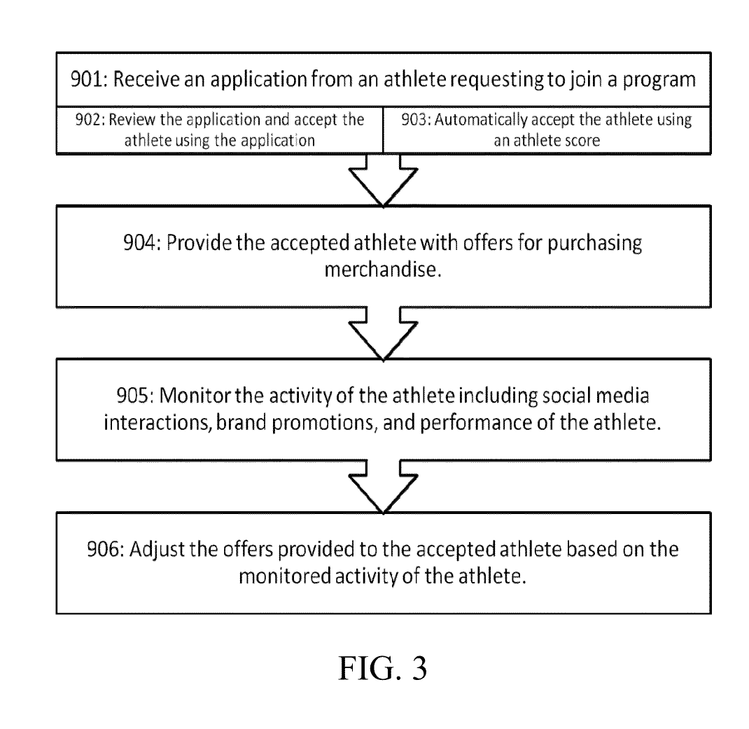

FIG. 3 is a diagram illustrating an example of a method for promoting a brand or a company. Referring to FIG. 3, in step 901, a user may receive an application from an athlete requesting to join a program and may review the application and accept the athlete in step 902 or may automatically accept the athlete using an athlete score in step 903. The user may then provide the accepted athlete with offers for purchasing merchandise, monitor the activity of the athlete, and adjust the offers provided to the athlete based on the monitored activity, as illustrated in steps 904, 905, and 906, respectively.

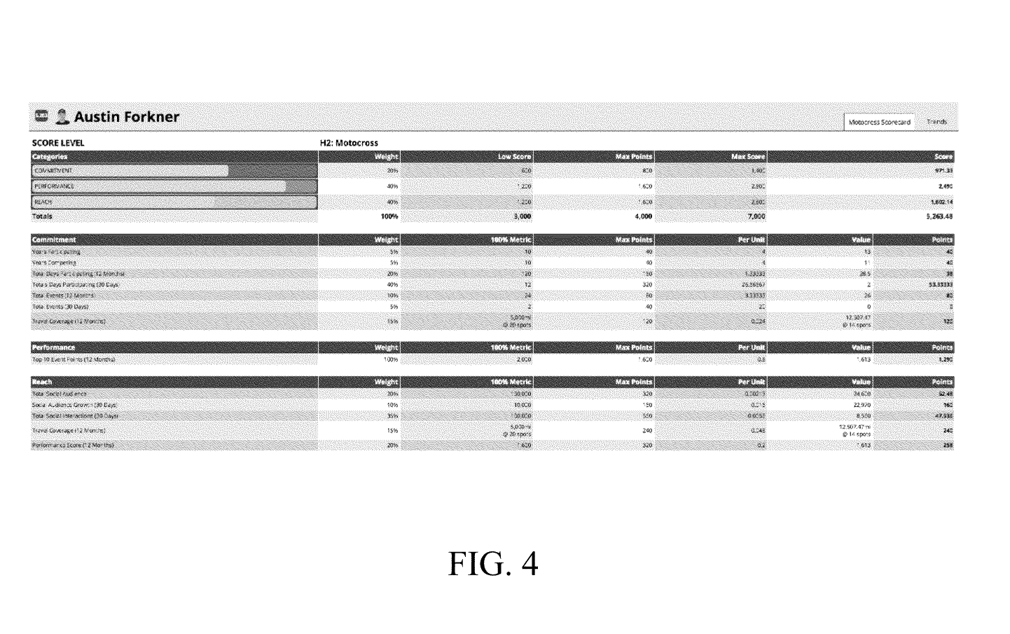

FIG. 4 is a diagram illustrating an example of an athlete score for an athlete who belongs to an H2 hierarchy and the athlete score is a weighted value of a commitment score, a performance score, and a reach score.

An athlete score is a number value for helping an athlete or company measure an athlete's value. The athlete score may be used by the athlete in comparing themselves to their own personal goals or to other athletes. The athlete score may be used by a company for comparing the athlete to other athletes for marketing, sponsorship, or other financial based purposes. Further, the athlete score may be publicly available for any individual such as a fan or media critic for comparing or assessing one or more athletes. In another example, the athlete score may be privately available to a select group or an individual such as any one or more of the athlete, a coach, a mentor, or team members for assessing or comparing one or more athletes. The athlete score may be referred to as a Hookit® Score.

Referring to FIG. 4, the athlete score is a number value which ranges from 0 to 1,000, but is not limited thereto. That is, the athlete score may be a number value within any range of values. The athlete score may be a value for an individual athlete such as in this example where the athlete value is for Austin Forkner. For example, the athlete score is a number value of 5,263.48 as shown under the “Score” column and the “Totals” row of FIG. 4.

The athlete score is a number value that is calculated based on different factors each having a number value. For example, the athlete score is calculated based on a value for an athlete's commitment, a value for an athlete's performance, and a value for an athlete's reach. Each of these values may be weighted equally to formulate the athlete score or may be weighted differently. In this example, the commitment, performance, and reach values are weighted differently at 20%, 40%, and 40%, respectively. Additionally, each of the commitment, performance, and reach values, may be calculated based on one or more factors which are weighted equally or differently to formulate each of the commitment, performance, and reach values.

For example, the commitment value for an athlete may be based on factors including one or more of the number of years the athlete participated or has been playing the sport, the number of years the athlete competed in the sport, the total number of days the athlete has participated in the sport over the past 2 months, the total number of days the athlete has participated in the sport over the past 30 days, the total number of events the athlete has participated in over the past 12 months, the total number of events the athlete has participated in over the past 30 days, and the travel coverage of the athlete over the past 12 months.

In this example, the commitment value is based on all of the above factors weighted at different percentages. The number of years the athlete participated or has been playing the sport is weighted at 5%, the number of years the athlete competed in the sport is weighted at 5%, the total number of days the athlete has participated in the sport over the past 2 months is weighted at 20%, the total number of days the athlete has participated in the sport over the past 30 days is weighted at 40%, the total number of events the athlete has participated in over the past 12 months is weighted at 10%, the total number of events the athlete has participated in over the past 30 days is weighted at 5%, and the travel coverage of the athlete over the past 12 months is weighted at 15%, thus making up 100% of the athlete's commitment value.

The performance value may also be based on one or more factors. For example, the performance value may be based on one or more of top 10 event points obtained over the past 12 month, all event points obtained over the past 12 months, and other statistics of an athlete's performance depending on their sport such as the number of touchdowns, receptions, tackles, rushing yards, field goals, home runs, base hits, goals, assists, among other statistics which should be appreciated by one of ordinary skill in the art. Each of these factors may be weighted equally or differently. In this example, the performance value is based exclusively on the top 10 event points obtained over the past 12 months, thus making up 100% of the athlete's performance value.

The reach value of an athlete may also be based on one or more values. The reach of an athlete may be a value which rates the athlete based on their influence or popularity within a confined group, a confined geographic region, or all over the world. Factors which may be weighted equally or differently include one or more of total social audience, audience growth over the past 30 days, total social interactions over the past 30 days, the athlete's travel coverage over the past 12 months, and the athlete's performance value or score. It should be appreciated that the time period over which a certain factor is monitored and considered is not limited to those described herein for any of the commitment, performance, or reach values or scores.

In this example, the reach value is based on all of the above factors weighted at different percentages. Total social audience is weighted at 20%, audience growth over the past 30 days is weighted at 10%, total social interactions over the past 30 days is weighted at 35%, the athlete's travel coverage over the past 12 months is weighted at 15%, and the athlete's performance value or score is weighted at 20%, thus making up 100% of the athlete's reach value.

In an example, the reach value may be based on social media platforms such as Facebook, Twitter, Instagram, and other social media platforms. Social media factors which are considered for determining the reach value of the athlete include, but are not limited to, the number of Facebook fans or friends an athlete has, the number of Twitter or Instagram followers an athlete has, the number of likes an athlete has received for comments or pictures posted over a past period of time, and the number of retweets and favorites an athlete has received over a past period of time. Additionally, the interaction of an athlete with a social media platform may be considered for determining the reach of the athlete. For example, the number of posts or shares the athlete publishes per day, the number of comments the athlete published over a past period of time, and other interactions of the athlete on the social media platform. Also, the performance score of an athlete may be factor used for calculating the athlete's reach score. Such social media data may be automatically detected from social media platforms and transmitted to an athlete score generating device 100 that is further described below in reference to FIG. 8.

The performance or attendance of different events may be weighted differently based on the impact of a major event. That is, factors of each of the commitment score, performance score, or reach score relating to a particular event may be multiplied based on the importance or impact of such an event. Accordingly, data obtained from different events may be equally weighted or weighted differently.

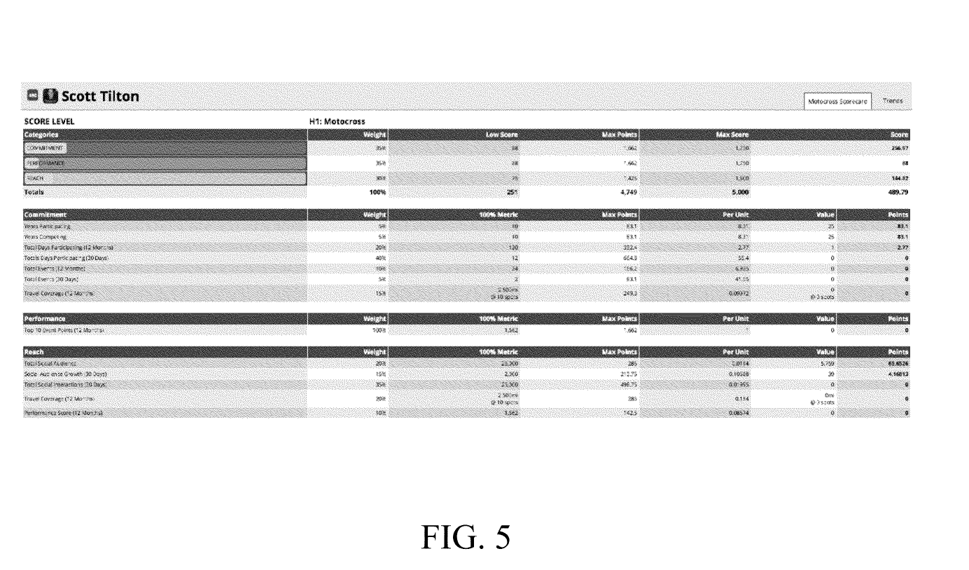

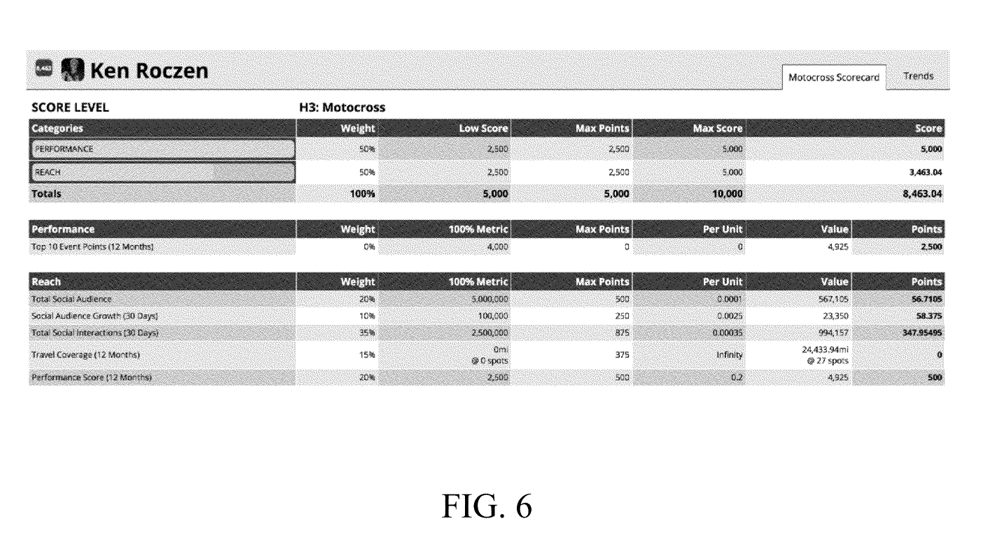

FIGS. 5 and 6 are diagrams illustrating examples of other athlete scores for an athlete who belongs to an H1 hierarchy, and an athlete who belongs to an H3 hierarchy, respectively.

Referring to FIG. 5, an athlete score for a different athlete such as Scott Tilton may have a different value. In this example, the athlete value for Scott Tilton is 489.79 which is less than the value of the athlete discussed with reference to FIG. 4. Accordingly, the athlete of FIG. 5 may be in a lower hierarchal group, H1, than the athlete of FIG. 4 who is in the group H2.

Referring to FIG. 6, an athlete score for another athlete such as Ken Roczen may have a different value. In this example, the athlete value for Ken Roczen is 8,643.04 which is greater than the value of the athletes discussed with reference to FIGS. 4 and 5. Accordingly, the athlete of FIG. 6 may be in a higher hierarchal group, H3, than the athletes of FIGS. 4 and 5 who are in the groups H2 and H1, respectively. For example, an athlete score ranging from 1 to 4,999 may place an athlete within the group H1, an athlete score ranging from 3,000 to 6,999 may place an athlete within the group H2, and an athlete score ranging from 5,000 to 10,000 may place an athlete within the group H3. It should be appreciated that any number of hierarchical groups and any range of athlete score values may be used for separating athletes into groups based on their athlete score.

Referring to FIGS. 4-6, the athlete value for an athlete within each of the groups H1, H2, or H3 may be calculated differently. For example, the weights for each of the commitment value, the performance value, and the reach value may be different for calculating the athlete score for athletes within different hierarchal groups. In the example shown in FIG. 4, for an athlete in the group H2, the commitment value may be weighted at 20%, and the performance and reach values may each be weighted at 40%. In the example shown in FIG. 5, for an athlete in the group H1, the commitment value may be weighted at 35%, the performance value may be weighted at 35%, and the reach value may be weighted at 30%. In the example shown in FIG. 6, for an athlete in the group H3, the performance value may be weighted at 50% and the reach value may be weighted at 50%.

Accordingly, one or more of the commitment value, performance value, and reach value may be omitted for athlete score calculations within certain groups. For example, the athlete scores for athletes within the highest group, H3, may be calculated without consideration for the commitment value because such athletes have already demonstrated their commitment to the sport. Also, the commitment value may have a smaller impact on the athlete score as an athlete score becomes greater and the athlete moves from a lower hierarchal group to a higher hierarchal group. That is, because an athlete has demonstrated their commitment to the sport, the commitment value becomes less pertinent to the athlete's overall value.

Further, factors discussed above that are used for calculating each of the commitment, performance, or reach values may be different for each of the hierarchal groups. For example, one or more of the factors considered for calculating the commitment score, one or more of the factors considered for calculating the performance score, or one or more of the factors considered for calculating the reach score may be different from one hierarchal group to another hierarchal group.

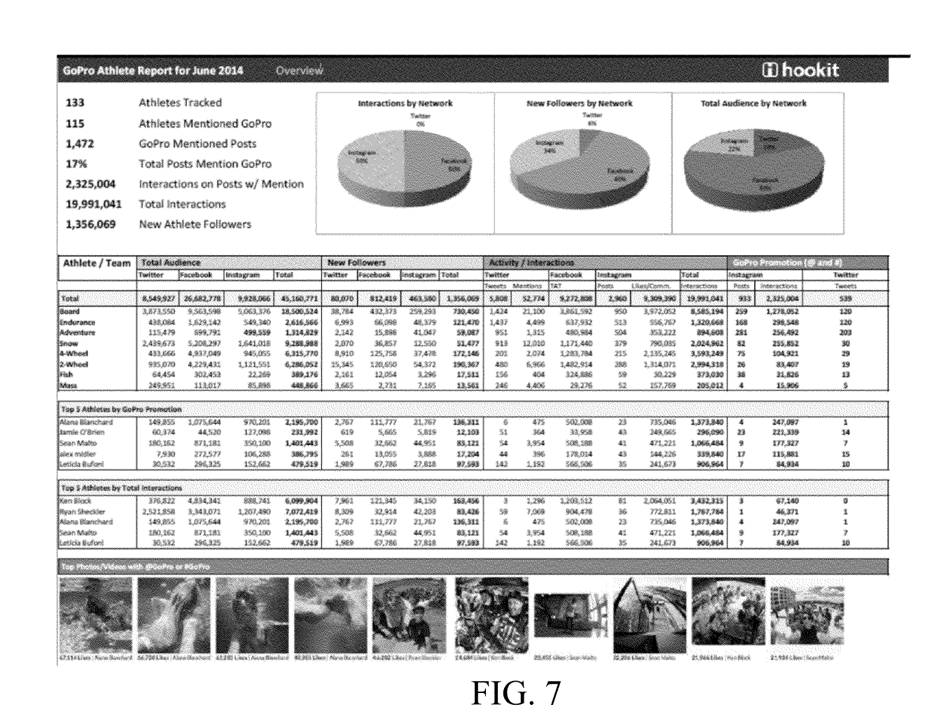

FIG. 7 is a diagram illustrating an example of an athlete report that may be provided to a specific company such as GoPro® and monitors a general value or a brand-specific value of one or more athletes.

Referring to FIG. 7, a number of athletes may be tracked over a period time for purposes of monitoring their general value or their value with respect to the marketability of a specific company, product, or brand. In this example, 133 athletes are tracked over a period of a month. The athlete report may provide data on the marketability of the tracked athletes based on data obtained from social media platforms. Additionally, an athlete report may incorporate data obtained on athletes such as the athlete score described above with reference to FIGS. 4-6.

For example, an athlete report includes information on the number of athletes tracked, the number of athletes who mentioned a specific company or brand such as GoPRO® on a social media platform, the number of posts or comments including a mention of the company, the percentage of posts or comments for all athletes or for each athlete that mentions the specific company, the number of interactions on posts or comments which include a mention of the company, the total number of interactions on a social media platform, and the number of new followers for an athlete. Additionally, charts and tables may be provided for easily displaying such information on the athlete report. For example, the number of interactions by network, the number of new followers by network, or the total audience by network may be illustrated.

Additionally, social media data may be separated according to sport and athlete to determine which sports or athletes are most valuable for marketing a particular brand or product, or for general marketing purposes. For example, a table may include the total number of audience members for each sport or athlete on each social media platform, a total number of new followers for each sport or athlete on each social media platform, the amount of activity and interactions for each sport or athlete on each social media platform, and the number of mentions or promotions of a particular brand or company, such as GoPro®, on each social media platform. Accordingly, all sports and athletes may be ranked based on any one or more of the data values obtained for monitoring the marketability of the sports or the athletes. For example, the top five athletes may be ranked according to their promotion of a brand or company, such as GoPro®, or the top five athletes may be ranked according to the number of total interactions to determine their general marketability. Also, the top photos or videos which are shared and include a promotion of a particular brand or company, such as GoPro®, may be identified and displayed on the athlete report.

As illustrated in FIG. 7, the total interactions, whether by athlete or with respect to a general sport, may be based on an athlete's activity or other users' activities relating to the athlete's activity on one or more social media platforms. For example, the total interactions may be calculated based on one or more of the number of tweets on Twitter, the number of mentions on Twitter, the athlete's Facebook page TAT (talking about this) number, and the number of Instagram likes or comments. Additionally, the number of promotions of a brand or company may be monitored by providing the number of Instagram or Twitter posts that tag the name of the brand, for example @GoPro or #GoPro, and the number of interactions by users on such posts.

FIG. 8 is a diagram illustrating an example of an athlete monitoring system including an athlete score generating device 100, an athlete report generating device 200, one or more social media platforms 300, and an athlete interface 400. An athlete score generating device 100 includes a performance score unit 101, a commitment score unit 102, a reach score unit 103, and an athlete score generating unit 104. The performance score unit 101, commitment score unit 102, and reach score unit 103 calculate a commitment score, a performance score, and a reach score according to the description provided above with reference to FIGS. 4-6. Accordingly, each of the commitment score, performance score, and reach score may be used by the athlete score generating unit 104 to generate the athlete score.

The athlete monitoring system may also include an athlete report generating device 200. The athlete report generating device 200 includes an athlete monitoring unit 201, a sport monitoring unit 202, and an athlete report generating unit 203. The athlete monitoring unit 201 and the sport monitoring unit 202 may monitor the social media activities related to an athlete or a sport according to the description provided above with reference to FIG. 7. Accordingly, the athlete report generating unit 203 may generate an athlete report based on the data provided by the athlete monitoring unit 201 and the sport monitoring unit 202.

The athlete score generating device 100 and the athlete report generating device 200 may communicate with one or more social media platforms 300. The athlete score generating device 100 and the athlete report generating device 200 may be wirelessly connected to one or more of the social media platforms 300 to automatically or manually receive social media data. For example, social media information may be used by the reach score unit 103 to calculate an athlete's reach score or used by the athlete monitoring unit 201 to monitor an athlete's social media activities. Also, an athlete score or an athlete report may be sent to or published on a social media platform.

The athlete score generating device 100 and the athlete report generating device 200 may also communicate with one or more athlete interface units 400. The athlete score generating device 100 and the athlete report generating device 200 may be wirelessly connected to one or more of the athlete interface units 400 to automatically or manually receive data inputs from athletes. For example, an athlete may share how active they are in their sport. Every time an athlete practices or participates in a competition, the athlete may post a session from an athlete interface unit 400 to get full credit applied to their athlete score. Also, athletes may receive athlete score information or athlete reports for tracking and challenging their own progression, or comparing their efforts by monitoring other athletes. Similar interfaces (not shown) may be included in the athlete monitoring system for use by companies, promoter, fans, or media critics for receiving athlete scores or athlete reports from the athlete score generating device 100 and the athlete report generating device 200.

Additionally, the athlete score generating device 100 and the athlete report generating device 200 may communicate with each other for generating an athlete score or an athlete report. For example, the athlete report generating device 200 may use the athlete score generated by the athlete score generating device 100 to generate the athlete report. Also, the athlete score generating device 100 may use data obtained by the athlete report generating device 200 to generate the athlete score.

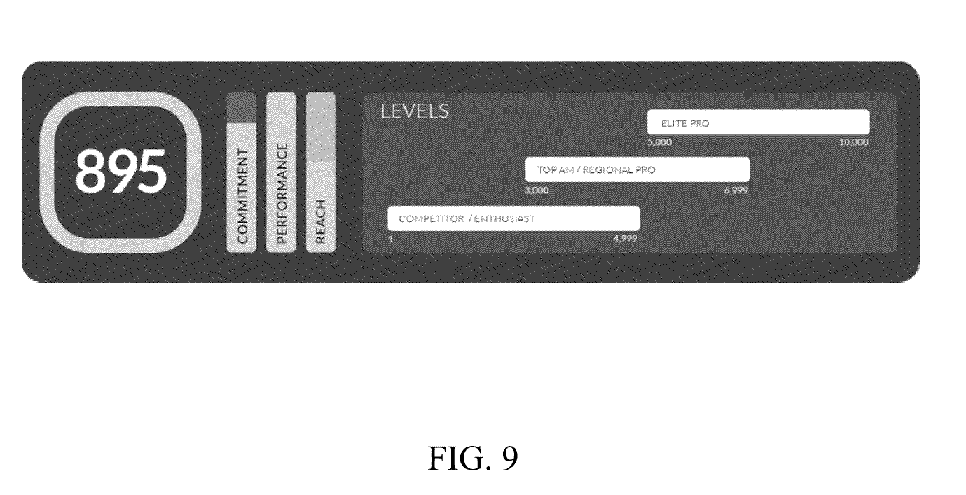

FIG. 9 is a diagram illustrating an example of a user interface display that includes a total athlete score and an indicator for each weighted score that forms the total athlete score, such as a commitment score, a performance score, and a reach score. As illustrated in FIG. 9, the total athlete score may be displayed in large font and highlighted for the athlete. In this example, the athlete score is 895. Also, the level of commitment, performance, and reach values may be represented on bar graphs or other types of graphs for identifying the magnitude of each factor, Additionally, other scores may be displayed for helping an athlete identify the hierarchal levels for all athletes using the athlete score.

It should be appreciated that the described athlete score may be used in connection with any number of different sport or related activities. That is, the athlete score is not limited to any particular sport, but can be used with any and all sports and athletic activities. Further, while the athlete score is described as a weighted score based on a commitment, performance, and/or reach value, it should be appreciated that the athlete score can be based on only one of these values or any combination of these values. Accordingly, the athlete score is not limited to a weighted score based on commitment, performance, and reach.

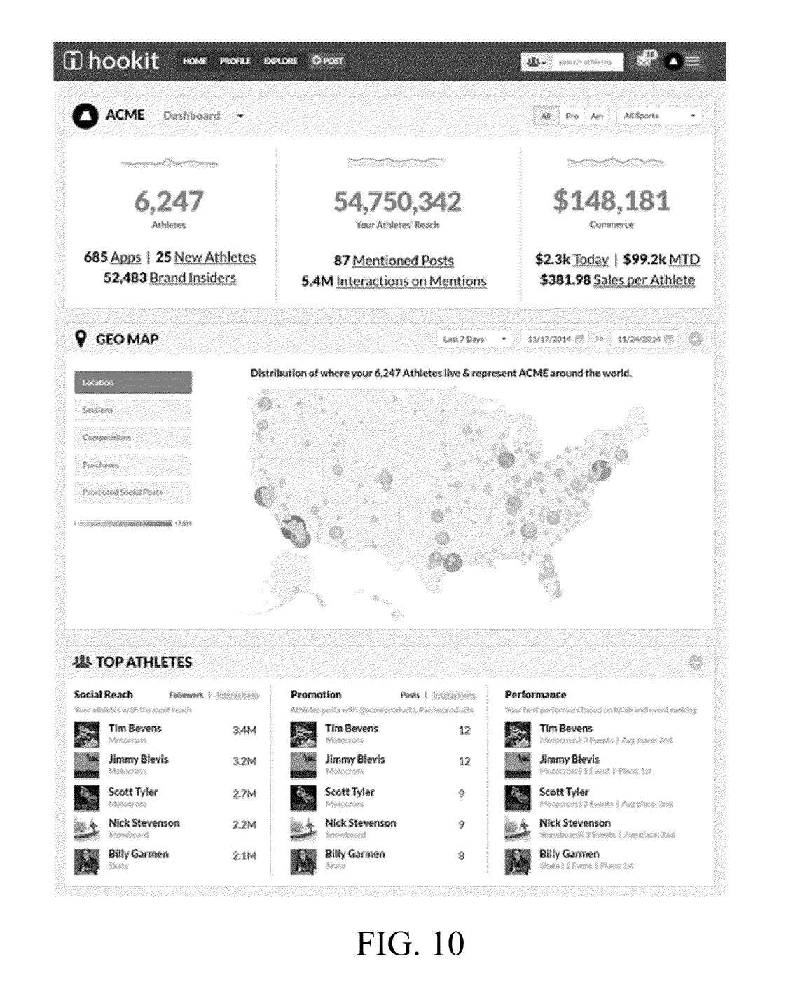

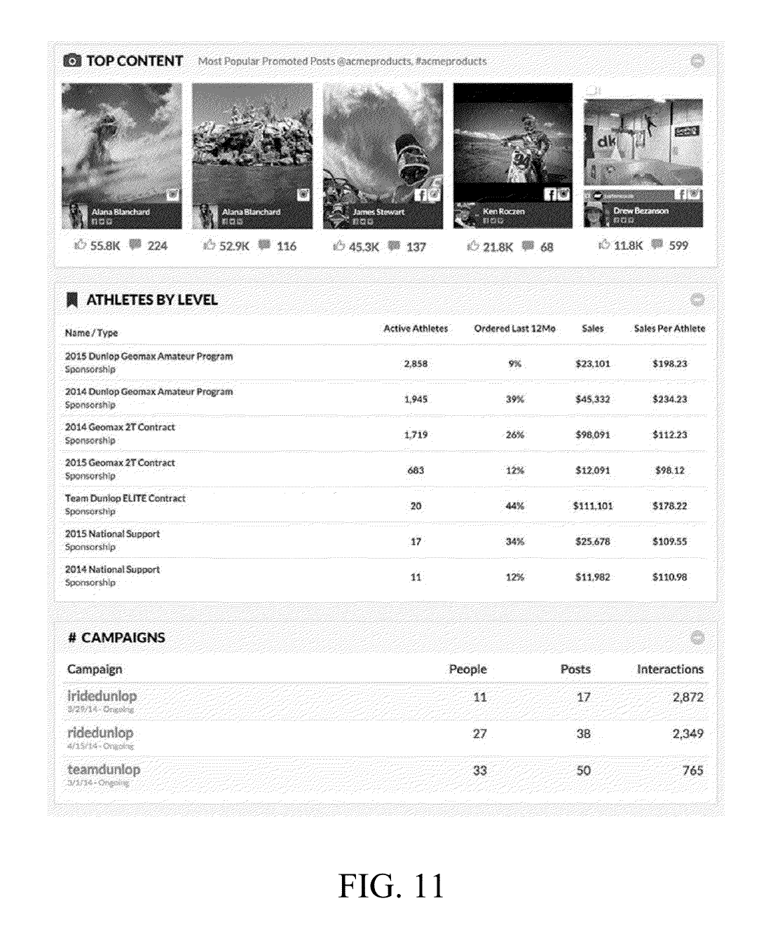

FIGS. 10 and 11 are diagrams illustrating an example of a dashboard for monitoring athlete activity including key metrics, an athlete map, a ranking of athletes, top social media content, athlete metrics by level, and hashtag campaign metrics. This dashboard may be used by a brand or a company for monitoring and ranking an athlete or a group of athletes. The athlete ranking and information may be updated every predetermined period of time, for example, every hour or other period of time to provide real-time monitoring.

Referring to FIG. 10, the dashboard includes key metrics such as the number of athletes enrolled in a program, the number of applications from athletes seeking enrollment, the number of new or recently enrolled athletes, and the number of brand insiders. The dashboard may also includes information on social impact and exposure of athletes, and sales information per day, per year, and per month. Additionally, the dashboard may include an athlete map that displays the location of where athletes live, compete, mention the brand, post social media content, participate in social media activities, or buy the company's product. Athletes may be ranked and top athletes may be identified and listed on the dashboard; for example, top athletes may be identified according to the different embodiments of the athlete score or other information such as which athletes are performing the best or promoting the brand the best. Also, athletes can be ranked by most followers on social media, highest engagement percentage, and athletes with the best most recent results according to a period of time.

Referring to FIG. 11, the dashboard also includes information on athletes by level, top content, and hashtag campaigns. Athletes, and information on athletes, may be divided according to level of athlete from armature to professional. Top athletes in each category may be ranked and displayed. Top content may be identified as popular posts from the athletes promoting the company brand in social media, and may be displayed on the dashboard. In this example, hashtag campaigns are tracked to identify all hashtags relating to the company or brand. Further, any hashtag used by athletes may be tracked or monitored and can be identified and displayed. For each displayed hashtag, the number of people, posts, and interaction may also be identified and displayed.

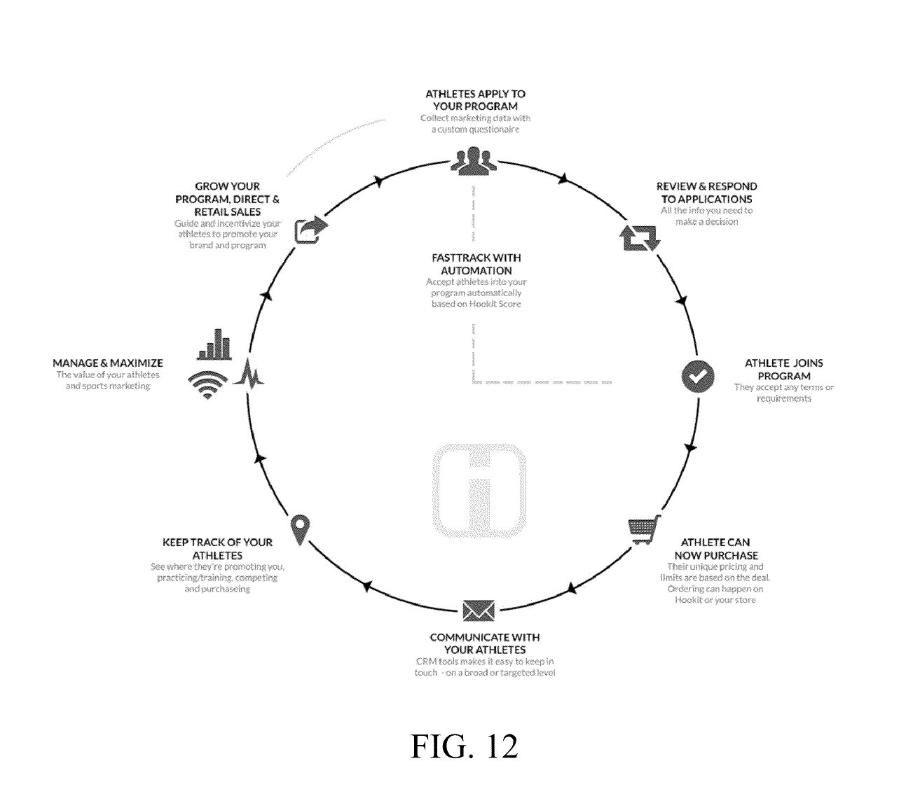

FIG. 12 is a diagram illustrating an example of a method for promoting a brand based on an athlete score or other athlete related metrics. An athlete may apply to a company's marketing program using a questionnaire relating to marketing data, the company may review and extend an invitation to the athlete based on the merits of the athlete's application, and the athlete may join the company's program and accept the terms of joining the program. Additionally, the company may accept athletes automatically based on an athlete's score, as described in the examples provided above on athlete scoring systems.

Once the athlete enrolls in a company's program, the athlete becomes eligible for unique pricing and offers for purchasing merchandise, the company can communicate directly with the athlete, and the company may monitor promoting and other activity of the athlete, as described above in reference to FIGS. 10 and 11. Using data provided from monitoring athletes enrolled in the company's program, the company may manage and maximize the value of athletes and sports marketing. For example, monitoring the most valuable athletes or sport markets allows the company to incentivize these athletes to further promote the product. Accordingly, the company will continue to grow the program and increase sales of merchandise based on promoting activities of athletes enrolled in the company program.

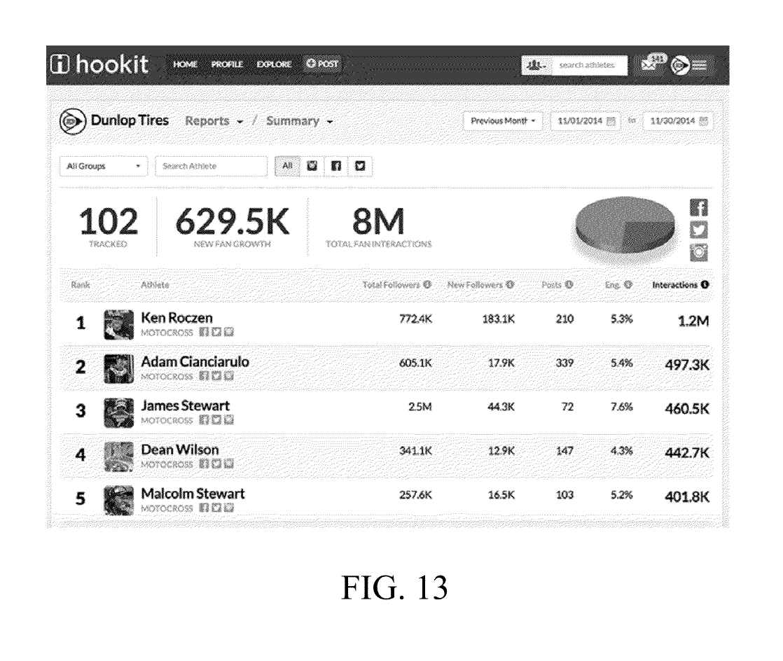

FIGS. 13-15 are diagrams illustrating an example of reports that may be provided to a specific company for monitoring the interactions of one or more athletes.

Referring to FIG. 13, an example of a report includes a summary that may be provided to a specific company such as Dunlop® and monitors the interactions of one or more athletes. The summary report includes information on how many athletes are tracked, the number of new or recent fan growth, and the total fan interaction with the tracked athletes. Further, athletes may be ranked by total followers, new followers, number of posts, engagement percentage, and/or number of social media interactions. In this example, the athletes are ranked by the number of total social media interactions. Additionally, athletes may be ranked according to sport or all athletes may be ranked together, and data may be grouped according to all social media platforms or according to a specific social media platform.

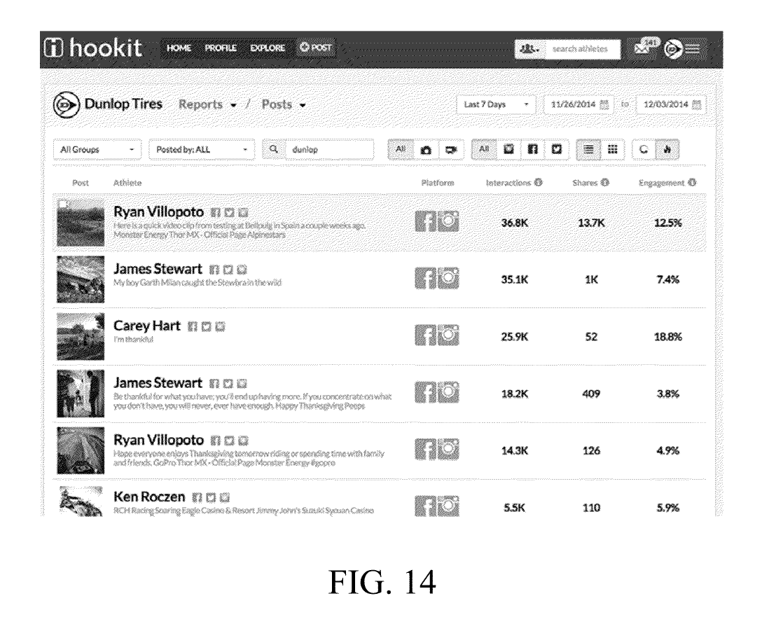

Referring to FIG. 14, an example of a report includes ranking of athletes' posts that may be provided to a specific company such as Dunlop® and monitors the interactions of one or more athletes. Athlete posts may be ranked according to total number of social media interactions, number of shares, or engagement percentage with the post. In this example, the posts are ranked by the total number of social media interactions. Additionally, as with the summary report, posts may be filtered according to a specific sport, and data may be grouped according to all social media platforms or according to a specific social media platform. Also, posts may be filtered according to type for distinguishing between posted pictures and videos.

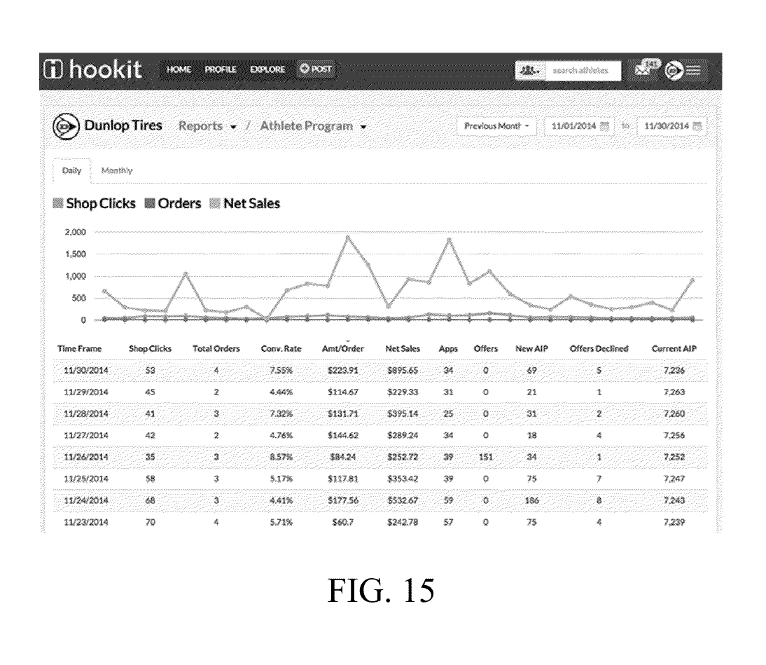

Referring to FIG. 15, an example of a report includes sales information that may be provided to a specific company such as Dunlop® and monitors the interactions of one or more athletes. The number of shop clicks, total orders, and net sales may be monitored and recorded. This report can be provided for a predetermined period of time, and more specific information can be provided for a smaller period of time within the predetermined period of time. In this example, the report is provided for November 2015 and specific information is provided for each day within the month of November. Specific information may include information on shop clicks, total orders, conversion rates, amount per order, net sales, applications, offers, new AIP, offers declined, and current AIP. Data can be provided on a graph including information on shop clicks, orders, and net sales, or other data.

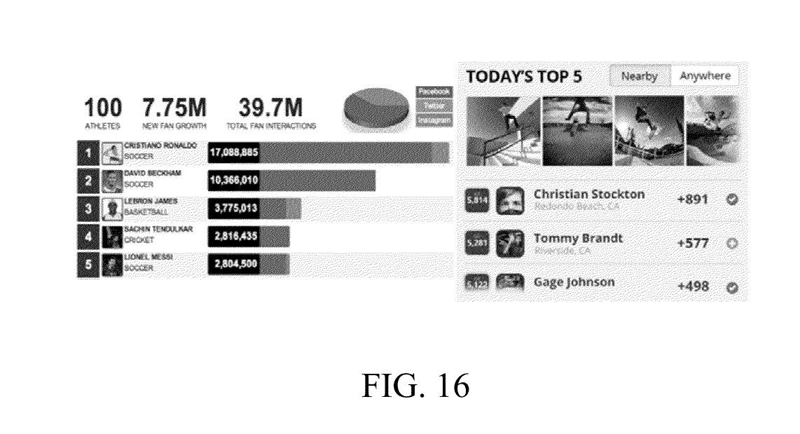

FIG. 16 is a diagram illustrating an example of athlete ranking Athletes may be ranked according to any number of data points; for example, performance, commitment, social reach, a weighted athlete score as described above, or components of such data points. In this example, athletes are ranked according to the number of fans and/or followers on social media platforms such as Facebook, Twitter, and Instagram. For example, the top 100 athletes for a particular sport or the top 100 athletes overall may be identified and ranked according to total fans and/or followers, and new fan growth and total fan interactions for the top 100 athletes may be displayed. Further, the top five athletes having the greatest number of new fans and/or followers over a predetermined period of time may be ranked and displayed. In this example, the top five athletes in a nearby location and having the greatest number of new fans and/or followers over the past day are ranked and displayed. Also, the top five athletes in any location over the past day may be ranked and displayed. Accordingly, in an aspect, athletes are ranked overall and by sport every month based on their social interactions and follower growth.

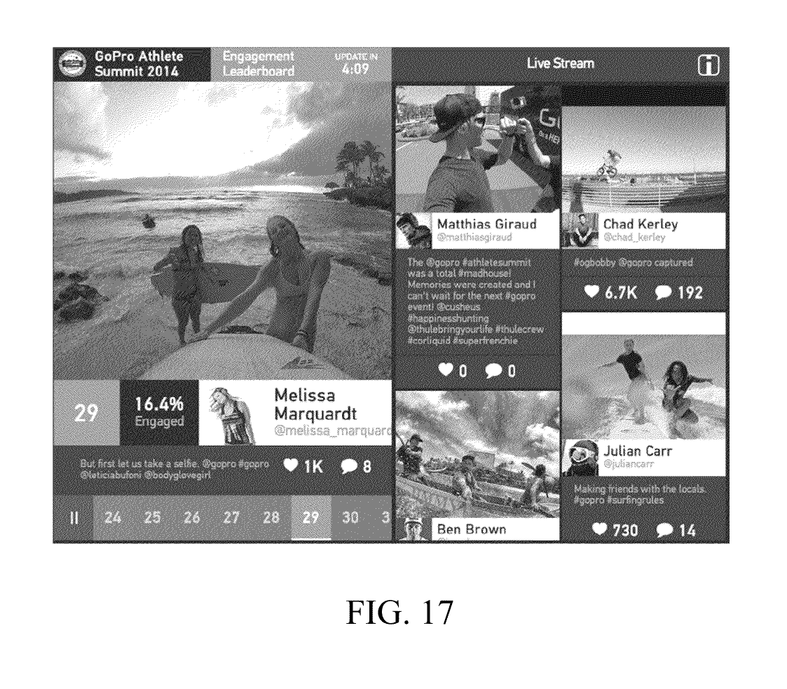

FIG. 17 is a diagram illustrating an example of an engagement ranking and live stream during an event. Athletes participating at an event are ranked in several ways: by total social interactions, new followers, and total followers. Athletes are also ranked by their best individual posts based on interactions or engagement percentage.

Referring to FIG. 17, an engagement leaderboard during the event displays the athletes or the posts having the highest engagement percentage including a copy of the post, the number of likes, the number of comments, the name of the athlete, and the engagement percentage for each post. A predetermined number of athletes or posts are ranked; for example, the top 100 posts or the top 100 athletes, or all athletes participating in the event are ranked.

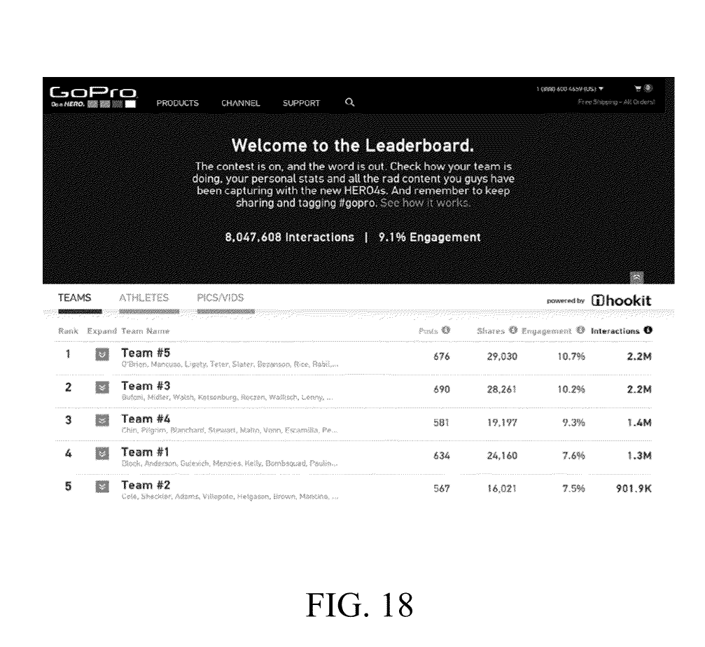

FIG. 18 is a diagram illustrating an example of ranking teams including one or more users and/or athletes. For example, each team includes a group of users and the collective user activity for each team is used for ranking purposes. In this example, the teams are ranked according to the number of interactions; however, teams may also be ranked by engagement percentage, number of shares, and number of posts. The total number of interactions and engagement percentage during an event or contest may also be monitored and displayed.

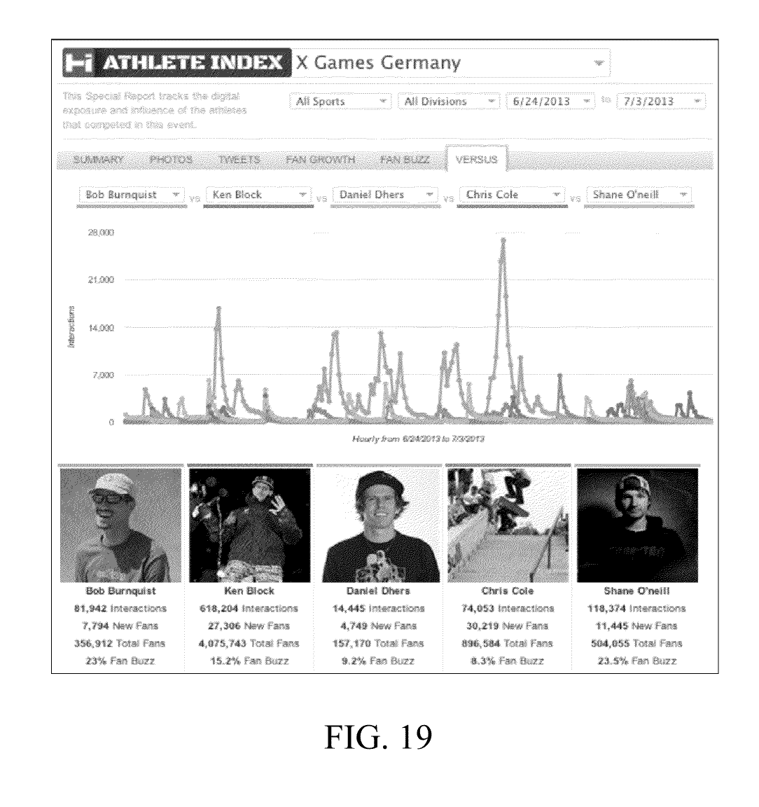

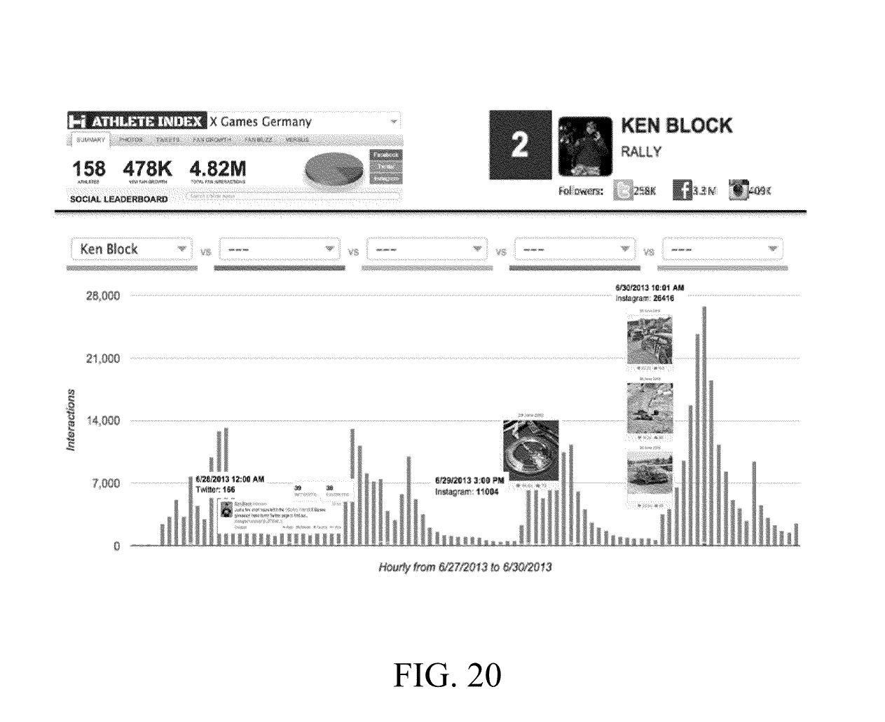

FIGS. 19 and 20 are diagrams illustrating examples of a chart monitoring the interactions of one or more athletes during an event. Referring to FIG. 19, the one or more athletes are compared by hourly interactions over a predetermined period of time; for example, five athletes are compared over a period of two weeks or one month. The number of hourly interactions for each athlete may be graphed on a line chart and data for each athlete may be displayed by total number of interactions, new fans, total fans, and fan buzz percentages. Referring to FIG. 20, the activity of one or more athletes is illustrated on a bar graph where the number of hourly interactions over a predetermined period of time is monitored and displayed. For example, the number of interactions per hour is displayed and the posts generating interactions are also displayed on the bar graph. Even though only one athlete's activity is illustrated on the bar graph, the activity of more than one athlete may be compared in the bar graph as with the line graph.

In another example, athletes may be ranked at a particular spot or venue to generate “spot” ranking Similar to event rankings, athletes that participate at a particular venue (i.e. motocross track, skate park, basketball court, race track, golf course, etc.) are ranked. Athletes that have recently participated at the spot are ranked by their Hookit Score or other component scores. Photos and Videos posted are ranked by their total interactions or engagement percentage. Spots, such as the as a skatepark or stadium may have TV's displaying the rankings and live stream of the photo/video leaderboard. Also, live broadcasts of events or at a particular venue may reference ranking information or athlete score information that is generated by an athlete scoring and/or athlete ranking system.

FIG. 21 is a diagram illustrating an example of an athlete monitoring system. As described above with reference to FIGS. 1, 2, and 8, an athlete monitoring system may include an athlete score generating device 100, an athlete report generating device 200, one or more social media platforms 300, and an athlete interface 400. These devices and/or interfaces are described above with reference to FIG. 8, of which description is also applicable with reference to FIG. 21.

Referring to FIG. 21, an athlete monitoring system may also include an athlete rank generating device 500. An athlete rank generating device 500 may include a data receiving unit 501, an athlete ranking unit 502, and an athlete rank generating unit 503. The data receiving unit 501 may receive data on athletes' social media activity from the one or more social media platforms 300 and/or information on athlete scores from the athlete score generating device 100. The data receiving unit 501 may transmit this data to the athlete ranking unit 502 which may process the data and transmit the processed data to an athlete rank generating unit 503. The athlete rank generating unit 503 may generate a ranking of athletes according to several different examples described above such as by social media activity, an athlete score, components of an athlete score, among other rankings.

The athlete rank generating unit 503 may directly generate a ranking report that may be used in a variety of different applications such as company dashboards, company reports, live TV broadcasts, top 100 or top five athlete reports, online live stream and leaderboard reports for an event or at a particular spot or venue, team contests, athlete comparison reports, among other applications. It should be appreciated that the athlete rank generating device 500 may communicate with the report generating device 200 to generate any of the described reports, or may be integral with the report generating device as a combined report and rank generating device.

It should be appreciated that the athlete scoring and ranking system 14, the athlete score generating device 100, the athlete report generating device 200, the athlete rank generating device 500, and other units or modules, are configured to perform athlete scoring, monitoring, or ranking for large groups of user or athletes. Further, the resulting output information is configured to be provided to a large number of potential users including social media followers, fans, companies, and other users. Accordingly, a large quantity of input data is received and processed for performing the described scoring, monitoring, and ranking operations. Further, data processing for the above described devices, modules, and systems requires an exponential number of operations that are a function of multiple data inputs relating to more than one athlete. That is, athlete scoring, monitoring, and ranking processes are a function of input data provided by many athletes where the number of operations required to perform such processes increases non-linearly with an increase in the number of athletes considered.

It should be understood that similar to the other processing flows described herein, the steps and the order of the steps in the flowchart described herein may be altered, modified, removed and/or augmented and still achieve the desired outcome. A multiprocessing or multitasking environment could allow two or more steps to be executed concurrently.

While examples have been used to disclose the invention, including the best mode, and also to enable any person skilled in the art to make and use the invention, the patentable scope of the invention is defined by claims, and may include other examples that occur to those of ordinary skill in the art. Accordingly the examples disclosed herein are to be considered non-limiting. As an illustration, an athlete score and/or a ranking of athletes may be generated using a number of different factors or based on a single factor.

It is further noted that the systems and methods may be implemented on various types of data processor environments (e.g., on one or more data processors) which execute instructions (e.g., software instructions) to perform operations disclosed herein. Non-limiting examples include implementation on a single general purpose computer or workstation, or on a networked system, or in a client-server configuration, or in an application service provider configuration. For example, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. For example, a computer can be programmed with instructions to perform the various steps of the flowchart shown in FIGS. 3 and 12.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable storage media including computer storage mechanisms (e.g., non-transitory media, such as CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. An athlete score generating device for generating an athlete score for an athlete, comprising:
a commitment score calculator for execution upon one or more data processors and configured to calculate a commitment score using one or more commitment factors;
a performance score calculator for execution upon the one or more data processors and configured to calculate a performance score using one or more performance factors;
a reach score calculator for execution upon the one or more data processors and configured to calculate a reach score using one or more reach factors; and
a total score generator for execution upon the one or more data processors and configured to generate the athlete score using at least one of the commitment score, the performance score, and the reach score,
wherein the commitment score calculator, the performance score calculator, the reach score calculator, and the total score generator comprise at least one processor.

2. The athlete score generating device of claim 1, further comprising a hierarchy calculator configured to calculate a hierarchy level of the athlete using the athlete score.

3. The athlete score generating device of claim 2, wherein the total score generator is configured to generate the athlete score using a ratio of at least one of the commitment score, the performance score, and the reach score, and to adjust the ratio used to generate the athlete score using the calculated hierarchy level.

4. The athlete score generating device of claim 2, wherein in response to the hierarchy level being within a first range, the total score generator is configured to generate the athlete score using the commitment score, the performance score, and the reach score, and in response to the hierarchy level being within a second range, the total score generator is configured to generate the athlete score using only the performance score and the reach score.

5. The athlete score generating device of claim 4, wherein the hierarchy level within the first range corresponds to a lower athlete score than the hierarchy level within the second range.

6. The athlete score generating device of claim 1, wherein the one or more commitment factors comprise any one or more of a number of years the athlete participated in a sport, a number of years the athlete competed in a sport, a number of days the athlete participated in a sport over a predetermined period of time, a total number of events the athlete participated in over a predetermined period of time, and total travel coverage of the athlete over a predetermined period of time.

7. The athlete score generating device of claim 1, wherein the one or more performance factors comprise any one or more of top event points obtained over a predetermined period of time, and statistics of the athlete during at least one competitive event over a predetermined period of time.

8. The athlete score generating device of claim 1, wherein the one or more reach factors comprise any one or more of total social audience on a social media platform, audience growth over a predetermined period of time on a social media platform, total travel coverage of the athlete over a predetermined period of time, a number of interactions of the athlete on a social media platform, and a level of activity relating to interactions of the athlete on a social media platform.

9. The athlete score generating device of claim 8, wherein the one or more reach factors further comprise the performance score.

10. An athlete score generating device, comprising:
an athlete score generator for execution upon one or more data processors and configured to generate an athlete score using a ratio of at least one of a commitment score, a performance score, and a reach score; and
a hierarchy calculator for execution upon the one or more data processors and configured to calculate a hierarchy level of an athlete using the athlete score,
wherein the athlete score generator is configured to adjust the generating of the athlete score using the hierarchy level calculated by the hierarchy calculator, and the athlete score generator and the hierarchy calculator comprise at least one processor.

11. The athlete score generating device of claim 10, wherein in response to the hierarchy level being within a first range, the athlete score generator is configured to generate the athlete score using the commitment score, the performance score, and the reach score, and in response to the hierarchy level being within a second range, the athlete score generator is configured to generate the athlete score using only the performance score and the reach score.

12. An athlete rank generating device, comprising:
a data receiving unit for execution upon one or more data processors and configured to receive data on social media activities of athletes or calculated athlete scores;
a ranking unit for execution upon the one or more data processors and configured to calculate a ranking of the athletes using the received data; and
a rank generator for execution upon the one or more data processors and configured to generate a ranking of the athletes using the calculated ranking,
wherein the data receiving unit, the ranking unit, and the rank generator comprise at least one processor.

13. The athlete rank generating device of claim 12, wherein the rank generator is further configured to transmit the generated ranking to an athlete report generating device for generating a report on the athletes comprising at least one of a number of the athletes for which the report is generated, a number of the athletes that mention a brand in social media activities, a promotion ranking of the athletes by total number of social media posts promoting a brand, and a total interactions ranking of the athletes by total social media interactions.

14. The athlete rank generating device of claim 12, further comprising a display for displaying the generated ranking on a user interface.

15. The athlete rank generating device of claim 14, wherein the user interface comprises at least one of a reach ranking of the athletes by total number of followers on social media platforms, a promotion ranking of the athletes by total number of social media posts promoting a brand, a performance ranking of the athletes by performance scores, a map displaying a location of activities by the athletes, a top content ranking of top content shared by the athletes, and a top hashtag ranking of top hashtags used in posts shared by the athletes.

16. The athlete rank generating device of claim 15, wherein the rank generator is further configured to update the generated ranking after a predetermined period of time and to transmit the updated ranking to the display for updating the user interface.

17. The athlete rank generating device of claim 12, wherein the athletes are participants in an event, and the ranking is based on activities of the athletes during the event.

18. The athlete rank generating device of claim 12, wherein the rank generator is further configured to transmit the generated rank to a television broadcast or to a display located at a sporting venue.

19. A method for promoting a brand using an athlete score, comprising:
receiving an application from an athlete requesting to join a program;
reviewing the application and accepting the athlete using the application, or automatically accepting the athlete using the athlete score without reviewing the application;
providing the accepted athlete with offers for purchasing merchandise; and
monitoring activity of the athlete including social media interactions, brand promotions, and performance of the athlete.

20. The method of claim 19, further comprising adjusting the offers provided to the accepted athlete based on the monitored activity of the athlete.
